(19) United States
(12) Patent Application Publication
(10) Pub. No.: US 2003/0033044 A1
(43) Pub. Date: Feb. 13, 2003

(54) Optimized process for producing tissue products

(76) Inventor: David Bilyeu, Alachua, FL (US)

Correspondence Address: VAN DYKE & ASSOCIATES, P.A., 7200 LAKE ELLENOR DRIVE, SUITE 252, ORLANDO, FL, 32809, US

(21) Appl. No.: 09/925,973

(22) Filed: Aug. 9, 2001

(51) Int. Cl. G06F 19/00

(52) U.S. Cl. 700/117; 623/901; 700/195

(57) ABSTRACT

A process of manufacturing tissue implant products with optimum use of material from irregularly shaped tissue stock. Also disclosed is a process of imaging tissue used for implant manufacture wherein data obtained from an imaging device, interfaces with a computer software system to create a production-yield analysis. By automating the evaluation and allocation processes associated with manufacture of implants, the current invention maximizes the amount of tissue recovered from donated samples, increases processing efficiency, decreases cost of production by eliminating the need for post machining sterilization, and improves the quality of product produced.

### FIELD OF THE INVENTION

This invention generally relates to tissue evaluation and allocation, and specifically relates to a process for maximizing tissue utilization and minimizing waste during the manufacture of tissue products used for implantation and transplantation procedures.

### BACKGROUND OF THE INVENTION

Advances in the field of tissue transplantation in recent decades has revolutionized patient care. Harvested tissue, both human and non-human, has been successfully transplanted to help thousands of people recover from degenerative disease or injury. Tissues such as bone, blood, skin, tendon, cornea, heart dura, fascia, tendons, ligaments and others are now used in a growing number of life saving or life enhancing medical procedures. The field of tissue harvest and transplantation has experienced significant growth in recent years to emerge into a full-fledged medical industry expected to exceed $1 billion in earnings by 2003 (MedTech Insights, 2000). In response to the increased demand for tissue, large tissue banks have emerged to coordinate donations in an effort to provide a steady supply of bone, tendons, cartilage, whole joints, and other tissue to research facilities and hospitals. In 1999, tissue banks distributed over 750,000 allografts for transplantation (Health and Human Services, OEI Report 01-00-0440, January 2001). In 1999 more than 20,000 donors provided cadaveric tissue, up from 6000 donors in 1994 (Health and Human Services, OEI Report 01-00-0440, January 2001). However, despite the success achieved by public and private groups to increase donations, the clinical need for tissue continues to outpace supply. For example, of the 3.6 million people who died in 1999, 50% were medically eligible to donate tissue, yet less than 0.4% donated tissue. This level of donation can not keep pace with the increasing number of patients in need of tissue transplants. Moreover, as the success rate of tissue transplantation continues to increase and become a more acceptable medical procedure, the demand for tissue will likely rise placing a greater strain on an already exhaustible resource, thereby increasing the number of patients who will be denied treatment.

Bone grafting is one of the most common forms of tissue transplantation in medicine. Aside from blood, harvested bone is the most commonly transplanted tissue. It has been estimated that over 200,000 people receive some type of bone transplant each year in the USA alone. (Medical College of Georgia, 2000). Typically, bone used in these procedures has been harvested from the patient's own body for re-implantation. An alternative procedure that has rapidly gained acceptance utilizes bone harvested from a cadaver (allogenic) or animal (xenogenic) source and subsequently processed for use in living patients. Bone from allogenic sources currently account for roughly 34% of the current bone substitutes, due in large part to advances in sterilization techniques.

A shortage of available bone tissue for transplantation has lead to an explosion in the field or orthobiologics as researchers have sought to find bone substitutes. Products containing osteogenic precursor cells, bio-active bone substitutes or osteoinductive proteins have been developed to replace bone and aid tissue regeneration. Many of these products have been crafted to perform a specific function, i.e. a screw, anchor, block or other device. However, manufactured products are often inferior alternatives to bone because they contain synthetic materials that have no regenerative capabilities and are simply absorbed over time following implantation. Others products fail to provide the necessary structural integrity inherent in bone. Thus, bone substitutes do not provide a complete remedy to the problems associated inadequate tissue donation.

In the field of orthopedic surgery the current trend has been to use functional implants made entirely from bone. Typically, a bone sample is crafted to a desired design, which once implanted, is capable of performing a specific function, i.e. a bone screw used to attach a ligament to existing bone. However, multiple problems exist with the current methods of manufacturing bone implants. First, as scientists refine techniques of manufacturing functional implants made entirely of bone, the demand for bone will likely increase, placing greater strain on the available supply. Second, the current method evaluating and allocating tissue stock used to manufacture such devices is a time and labor intensive process involving primary sterilization, handling, processing, and post machining sterilization. Third, inefficiencies in the processing of irregularly shaped tissue stock often results in excessive waste of tissue. Fourth, the costs associated with multiple sterilizations increases the total costs of manufacture, thereby raising the cost of production, which in turn increases the price of the product effectively eliminating treatment options for many patients. Fifth, product quality is often inconsistent. Thus, the inability of current trends in donation to meet the current and expected demand for bone products must be addressed if the medical industry is to continue to provide the best treatment available to the greatest number of patients in need. Therefore, a need exists in the field for a process of manufacturing tissue implants that maximizes the amount of implantable material recovered from each donation, minimizes waste, reduces the cost of production, and consistently generates a high quality product.

Accordingly, it is an object of the present invention to provide a process for the sterile manufacture of bone products that maximizes utilization of available tissue and minimizes waste.

It is another object of the present invention to provide a process for increasing the efficiency of processing tissue used in the manufacture of implant products.

It is another object of the present invention to provide a process of imaging tissue to generate a production-yield analysis.

It is another object of the present invention to provide a process that reduces the costs associated with manufacturing implantable tissue products.

It is yet another object of the present invention to provide a process for manufacturing implantable tissue products without the need for post-manufacture sterilization.

It is still another object of the present invention to provide a process for ensuring consistent quality of manufactured implant products.

Further objects and advantages of this invention will become apparent from a review of the complete disclosure, including the claims which follow.

### BRIEF DESCRIPTION OF THE DRAWINGS

FIG. 1. shows a schematic of one embodiment of an automated apparatus that may be used to effect the process of the present invention.

FIG. 2. shows a schematic of one embodiment of parallel automated apparatus' that may be used to increase production of implant products manufactured according to the process of the current invention.

### SUMMARY OF THE INVENTION

The present invention provides a process for the sterile manufacture of implant products made from bone or other tissues with optimum material use from irregularly shaped stock. Tissue is imaged using an imaging device, whereby data from the imaging device interfaces with software in a computer system to generate a tissue production-yield analysis, thereby allowing a user to maximize the amount of implantable tissue recovered from a given sample, and decrease cost of production. An algorithm is applied to dimensional data taken from an inventory of previously manufactured tissue products, to create a database of product templates. These templates are then matched with a given tissue sample based on similarity of dimensions and the tissue is given an enhanced design or pattern that will determine how the sample will be subsequently be processed. A computer reads the information and directs machines to process the tissue according to the dimensions of the template assigned, thereby creating the desired product. Optical scanners evaluate the finished product to ensure quality prior to packaging and labeling. All handling and machining occurs in a sterile, or class 100 environment throughout the process, eliminating the need for post-machining sterilization. By automating the processes of evaluation, allocation, and processing of tissue used to produce implant products, the present invention increases the efficiency of making implant products, thereby reducing the cost of manufacture and increasing the availability of tissue to treat patients in need.

### DETAILED DESCRIPTION OF THE PREFERED EMBODIMENTS

The increasing demand for tissues, particularly bone, for use in transplantation surgeries, and other medical or clinical procedures has continued to exceed supply. The present invention provides a method for the sterile manufacture of tissue implant products wherein, efficient processing is performed to maximize the amount of tissue recovered from a donated sample. Using a computer implemented product-yield analysis, tissue samples are measured and assigned a preferred, enhanced design based on the size of the tissue. This design ensures that the maximum amount of tissue is utilized from a given sample during manufacture of a product, thereby minimizing unnecessary waste of scarce tissue, and decreasing the cost of production. Accordingly, optimal use preferably refers to that use that produces the largest number of a given design per mass of tissue. Optimal use may also include that use that produces the largest number of any two or more designs per mass of tissue.

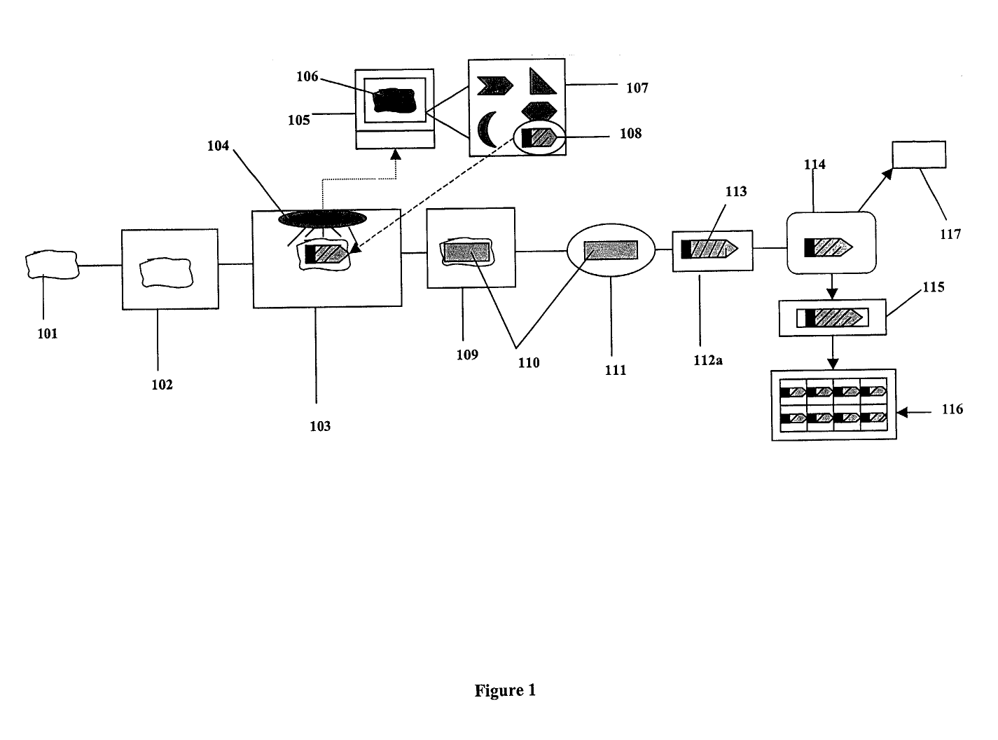

FIG. 1 shows a schematic of one embodiment of an automated apparatus that may be used to effect the process of the present invention. For purposes of the following description, allogenic bone is discussed as a preferred tissue used to create an implant according to the process of the current invention, and is not meant to be limiting. It should therefore be recognized that other types of tissues including, but not limited to, fascia, whole joints, tendons, ligaments, dura, pericardia, heart valves, veins, neural tissue, submucosal tissue, dermis, or cartilage, or combinations thereof and the like, from allogenic, autogenic, and xenogenic sources may also be used in the current process to manufacture an implant product. In a preferred embodiment, an individual irregularly shaped allogenic bone sample 101 is loaded into a sterilization chamber 102 and sterilized. As infection prevention is a top priority in health care, particularly in the field of tissue transplantation, adequate sterilization procedures are essential. This sterilization may include application of disinfectants and/or broad-spectrum antibiotic solutions, acid wash, boiling, or other sterilization processes, but is preferably carried out according to a proprietary, patent pending “BioCleanse” process (as taught in PCT/US99/26407, incorporated herein by reference). Validation studies have demonstrated that sterilization through use of this “BioCleanse” procedure kills or inactivates all classes of conventional pathogens, viruses, including HIV, microbes, bacteria, and fungi present in the tissue while retaining the bones useful properties and adequately reducing the potential for cross contamination. Bone treated according to this procedure becomes devoid of pathogenic material while retaining normal biomechanical properties and osteogenic/osteoinductive properties.

Once sterilized, bone is loaded into an “Optimizer” 103 wherein the bone sample 101 is scanned using an imaging device 104 that interfaces with a computer system 105 enabled with scan evaluation software and a design database. The data produced from scanning the image is then analyzed to determine the optimal design and quantity of a given design that corresponds to the dimensions of the tissue sample. Imaging may be conducted using infrared scanning techniques, x-rays, computer tomography (CT scan), optical scanning techniques, or other appropriate imaging processes. U.S. Pat. No. 4,152,767 discloses a method of measuring dimensions of an object using an array of photosensitive imaging sensors linked to a digital computer and is incorporated in its entirety herein by reference. U.S. Pat. No. 5,365,564 discloses a method for automated bone morphometry analysis using radiographs and is incorporated in its entirety herein by reference. Furthermore, scanning can occur by state of the art technology as taught at www.laserdesign.com and www.polhemus.com. and Dimensional data obtained from the scanning device is then inputted into a computer system 105. Preferably, the computer system is enabled with a graphical software program that is used to construct a geometric image 106 of the sample. Dimensional data is analyzed in the computer system 105 and applied to an algorithm previously used to develop design templates 107 from data obtained from an inventory of previously manufactured bone products. Dimensional data taken from the scanned object is evaluated using the algorithm, and an optimal template design 108 and quantity thereof is assigned to the bone sample 101. Correlating the template design 108 dimensions with those of the bone (or other tissue type) sample optimizes tissue utilization and minimizes waste generated during subsequent machining. Once an optimal template design 108 has been selected and stored in computer memory, the bone sample 101 is sent to a cutting machine 109 utilizing a combination of metal blades, water jet cutting, lasers, or other cutting devices, to form a blank 110. The blank 110 is cut such that sufficient material remains to allow manufacture of a bone product similar to the optimal design previously assigned in the optimizer 103. U.S. Pat. No. 3,856,219 discloses a bone mill for use in converting cadaver bone into controlled fragments and is incorporated herein by reference.

The bone blank 110 is placed in a sorter 111, wherein the specific machining requirements needed to manufacture the product are determined. The blank 110 is then routed to an appropriate milling machine to complete manufacture. For example, a bone blank 110 with an optimal template design 108 corresponding to a screw would be directed to an automated milling machine 112a designed to craft the grooves 113 and other features in the screw. Once the bone sample has been milled to create the desired product, it is sent to an automated inspection apparatus 114, wherein it is inspected to insure product quality.

Alternatively, the process may be streamlined such that immediately after scanning the tissue sample, and the optimal design and quantity are identified, the tissue is automatically routed to the milling machine, whereby the milling machine machines the product in accord with the specifications and coordinates determined by the optimizer. This alternative embodiment can be adapted to work with or without the intermediate blank cutting device and sorting device.

Preferably an optical inspection station is set up such that finished tissue products are optically inspected to verify that the product meets specified quality requirements. Ideally, the inspection station comprises a plurality of video cameras, mounted such that separate x, y and z coordinate planes may be viewed optically to ensure complete inspection of the product. However, those skilled in the art will recognize that any number of configurations or combinations of components may be acceptable for inspection. For example, to inspect a screw, cameras or other optical inspection devices would necessarily be configured at different angles than cameras set to inspect a block or other product of substantially different shape. As each product moves past the video cameras or other inspection components, a quality assurance system determines whether the product is acceptable or unacceptable. If the sample is accepted it will proceed to a packaging apparatus 115 where it will be packaged and labeled according to graft size and donor and sent on to storage 116. If rejected, the sample will be diverted to a holding apparatus 117 for quality or machine inspection. WO Patent No. 940,231 discloses an optical sorter device employing laser light and infrared light sensors connected to digital camera equipment to determine whether a product is to be accepted or rejected, and is incorporated herein by reference. Preferably, packages containing the finished bone product are terminally sterilized by Sterrad™ processes, but may be sterilized by gamma irradiation, vapor phase exposure or other appropriate package sterilization methods known in the field. Sterilized packages are then manually removed from the packaging apparatus 115 and sent to storage 116.

To maintain sterilization throughout the entire process, bones are kept in sterile containers during transport from one location to another. All mechanical components are sterilized. This allows the entire process to be carried out in either a sterile environment or in a controlled environment, such as, for example, a class 100 environment, thereby eliminating the need for post machining sterilization of the bone product. By class 100 environment is meant a room in which the atmospheric environment contains less than 100 particles of 0.5 microns in diameter per cubic foot of air conditioned space. By automating the evaluation and allocation process for manufacturing bone, the manufacturing process is expedited and the costs of production are reduced.

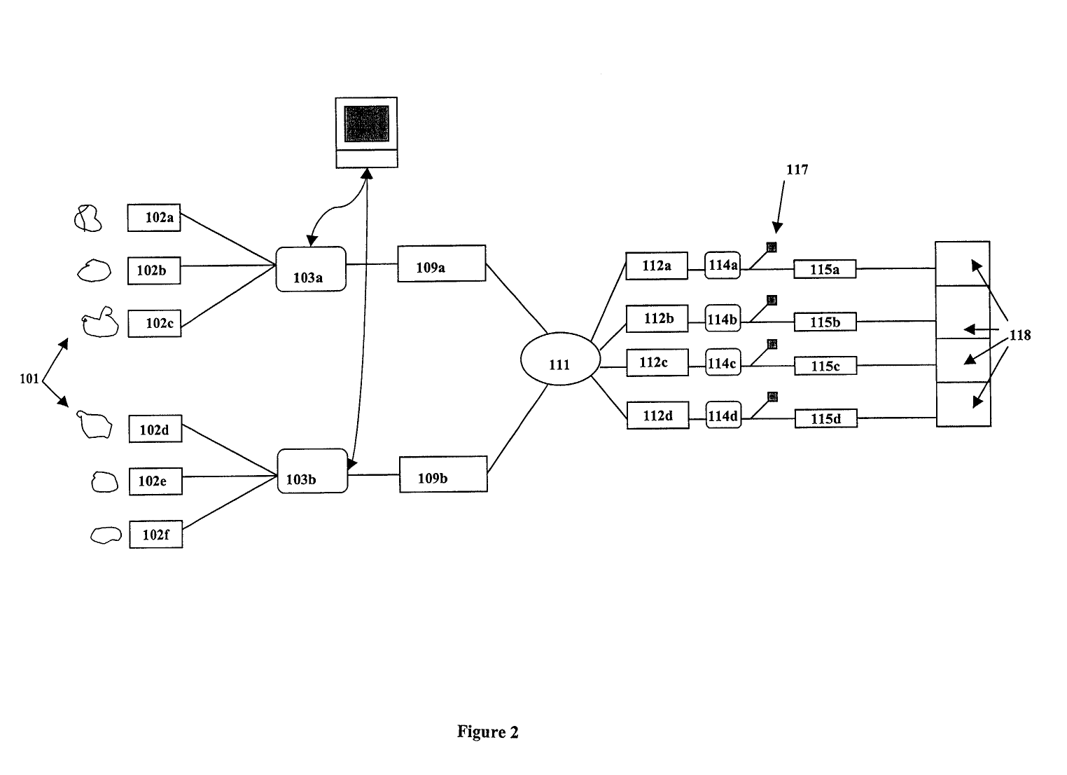

FIG. 2 shows a second embodiment of a representative system designed to allow simultaneous processing of multiple bone or other tissue samples according to the present invention. To increase production and help meet the demand for tissue products, two identical processing apparatuses are combined. As shown, six samples of irregularly shaped bone 101a-e are placed into individual processing chambers 102a-f for sterilization according to the process described above. Individual sterilized bone samples are then loaded one at a time into either of two optimizer units 103a,b for analysis and application of an enhanced design as described above. As each sample is analyzed, it is forwarded to either of two cutting machines 109a-b to construct a bone blank of appropriate dimensions. Blanks are loaded into a sorter 111 and routed to an appropriate milling machine enabled to craft a design from the blank identical to the template assigned, as described above. For example, as shown the sorter 111 may send a blank 110 to a machine enabled to create pins 112a, screws 112b, SR 112c or tangents 112b. To maximize machine efficiency, automated milling machines will not invoke a new sample until one or more blanks 110 are in the sorter. Once processed, the finished product is routed from the respective milling machine into an appropriate inspection apparatus 114a-d configured to inspect a particular product, e.g. pins 114a, screws 114b, SR 114c or tangents 114d, as describe above. Accepted products are sent to packaging stations 115 for packaging, labeling and terminal sterilization prior to being placed in storage 116 Rejected products are ejected into a holding area 117 for further review. Those skilled in the art will recognize that multiple variations of the present configuration may be employed to achieve the same results. For example, sales projections or actual orders may be fed into the computer system and used to allocate tissues and assign preferred templates thereby ensuring that manufacturers have adequate stock of a specific implant product to meet consumer demand. Combining multiple automated systems permits manufacture of implant products at economies of scale not possible with manual procedures thereby optimizing recovery of available tissue from each donation, minimizing waste, reducing the cost of manufacture, and increasing product quality.

Alternatively, the process is streamlined such that immediately after scanning the tissue sample, and the optimal design and quantity are identified, the tissue is automatically routed to the milling machine, whereby the milling machine machines the product in accord with the specifications determined by the optimizer. This alternative embodiment can be adapted to work with or without the intermediate blank cutting device and sorting device.

The disclosure of all patents and publications cited in this application are incorporated by reference in their entirety to the extent that their teachings are not inconsistent with the teachings herein. It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A process for manufacturing a tissue implant comprising obtaining tissue to be processed; scanning said tissue to produce dimensional data of said tissue; analyzing said data by a computer system enabled with a database comprising a plurality of designs; and identifying one or more designs and quantity thereof that relate to an optimized use of said tissue, whereby one or more tissue products are produced in accord with said identified one or more designs and quantity thereof.

2. The process according to claim 1, wherein said at least one tissue sample is sterilized.

3. The process according to claim 1, wherein said at least one tissue sample is allograft, autograft, or xenograft tissue, or combinations thereof.

4. The process according to claim 3, wherein said at least one tissue sample is cortical bone, cancellous bone, fascia, dermis, whole joints, tendons, ligaments, dura, pericardia, heart valves, veins, neural tissue, or submucosal tissue, cartilage, or combinations thereof.

5. A process for manufacturing tissue implants comprising:
a. obtaining at least one tissue sample for processing;
b. sterilizing said at least one tissue sample;
c. scanning said at least one tissue sample to produce dimensional data corresponding thereto;
d. inputting said data into a computer system enabled with a database comprising a plurality of designs;
e. identifying one or more designs and quantity thereof that correspond to an optimal use of said at least one tissue sample; and
f. machining said at least on sample of tissue to produce one or more tissue products in accord with said one or more designs and quantity thereof.

6. The process according to claim 5, wherein said at least one tissue sample is allograft, autograft, or xenograft tissue, or combinations thereof.

7. The process according to claim 6, wherein said at least one tissue sample is cortical bone, cancellous bone, fascia, whole joints, tendons, ligaments, dura, pericardia, heart valves, veins, neural tissue, submucosal tissue, dermis, or cartilage, or combinations thereof.

8. The process according to claim 5, wherein said sterilization is achieved through a process that retains the bioactive properties of said at least one tissue sample.

9. The process according to claim 8, wherein said sterilization is achieved using a process selected from the group consisting of BioCleanse, acid wash, boiling, 100% ethanol, gamma radiation, ethylene oxide, disinfectants, broad spectrum antibiotic solutions or combinations thereof.

10. The process according to claim 5, wherein said scanning comprises disposing said at least one tissue sample in a container that interfaces with at least one scanning device positioned in, on, or proximate to said container to effectuate scanning of said tissue sample.

11. The process of claim 10, wherein said scanning device is enabled to scan said at least one tissue sample in x, y, or z coordinate planes, or combinations thereof.

12. The process of claim 11, wherein said scanning device generates dimensional data corresponding to the size and shape of said scanned tissue sample.

13. The process according to claim 5, wherein said computer system is enabled with a graphical software program designed to produce images.

14. The process according to claim 13, wherein said dimensional data is converted into numerical data.

15. The process of claim 14, wherein said numerical data is converted into an image by said graphical software program.

16. The process of claim 5, wherein said identifying step utilizes an algorithm to match said data with one or more preferred designs from said database relating to an optimal use of said tissue sample.

17. The process of claim 16, wherein said data is matched with said one or more preferred designs based on similarity of dimensions.

18. The process of claim 5, wherein said database is generated from compiling dimensional data from previously manufactured tissue implants.

19. The process of claim 5, wherein upon identifying said one or more template designs and number thereof, said at least one tissue sample is directed to a specific machining device selected from a plurality of machining devices, wherein said specific machining device is configured to machine said sorted tissue in accord with said template design.

20. The process of claim 5, further comprising cutting said at least one tissue sample into a blank prior to said machining, whereby said blank is cut to have dimensions appropriate for subsequent machining into said one or more designs and quantity thereof.

21. The process of claim 20, wherein said machining is conducted by a milling device that is contained in its own environment to thereby prevent contamination from the environment external to said milling device.

22. The process of claim 5, wherein said process further comprises inspecting said one or more tissue products for quality verification.

23. The process of claim 22, wherein said inspecting is conducted by optical inspection wherein cameras are positioned for remote viewing of said one or more tissue products

24. The process of claim 23, wherein said optical inspection comprises utilizing a plurality of video cameras, mounted such that separate x, y and z coordinate planes along said product may be viewed optically to ensure complete inspection of the product quality to accept or reject said product.

25. The process of claim 5 comprising packaging said one or more tissue products.

26. The process of claim 25, further comprising sterilizing said one or more tissue products by irradiation.

27. The process of claim 5, wherein sterilizing of at least one tissue sample comprises disposing said at least one tissue sample in a chamber and sterilizing said tissue in said chamber; and scanning said at least one tissue sample comprises scanning in said chamber, such that said at least one tissue sample remains sterilized during said scanning step.

28. The process of claim 5, wherein said at least one tissue sample is transferred between steps in sterilized containers.

29. The process of claim 5, wherein subsequent to machining said at least one tissue sample, said tissue is packaged, sterilized and stored.

30. The process according to claim 29, wherein package sterilization is achieved through Sterrad sterilization procedures.

31. An automated tissue processing system comprising:
a sterilization chamber; an optimizer unit comprising at least one scanning device interfaced with at least one computer system enabled by at least one analytical software program and a database comprising a plurality of template designs; a cutting device for cutting tissue into a desired tissue blank; a routing device for routing said tissue to an appropriate milling machine for machining said blank into a desired product; an inspection station for inspecting the quality of said product; a holding chamber for holding rejected products; a packaging station for packaging and labeling accepted products; and a storage station for storing products prior to shipment.

32. An automated process for manufacturing implantable tissue products comprising:
(a) selecting a tissue sample for processing; placing said tissue sample into a sterilized chamber, wherein said tissue sample is sterilized;
(b) transferring said sterilized tissue sample into a sterilized optimizer unit, wherein said tissue sample is scanned to obtain dimensional data corresponding to said tissue sample;
(c) inputting dimensional data from said sample into a computer system enabled with an analytical software program and a database comprising a plurality of designs;
(d) analyzing said dimensional data with said analytical software program to identify a design type and quantity thereof commensurate with the dimensions of said tissue sample to maximize tissue utilization;
(f) routing said tissue sample into a sterilized cutting machine wherein said tissue sample is cut into a tissue blank of sufficient size and shape to facilitate subsequent machining of said tissue product according to said design;
(g) transporting said container to a sorter;
(h) placing said blank into said sorter, wherein said blank is routed to a milling device enabled to machine a design from the blank in accord with said identified design and quantity thereof;
(i) milling said blank to produce a finished product in accord with said identified template design and number thereof;
(j) analyzing said finished product for quality;
(k) packaging and labeling said finished product;
(l) sterilizing said packaged product prior to storage; and
(m) storing said sterilized product for at least twenty-four hours.

32. An implant produced by the process of claim 1.

33. An implant produced by the process of claim 5.

34. A process for manufacturing tissue implants comprising:
a. scanning at least one tissue sample to produce dimensional data corresponding thereto;
b. inputting said data into a computer system enabled with a database comprising a plurality of designs;
c. identifying one or more designs and quantity thereof that correspond to an optimal use of said at least one tissue sample; and
d. routing said at least one tissue sample to a machining device, wherein said machining device is programmed with the specifications of said identified design to automatically machine said at least one tissue sample to produce a tissue product in accord with said identified design.
